(19) United States
(12) Patent Application Publication
(10) Pub. No.: US 2019/0235139 A1
(43) Pub. Date: Aug. 1, 2019

(54) HIGH PERFORMANCE VISIBLE WAVELENGTH META-AXICONS FOR GENERATING BESSEL BEAMS

(71) Applicant: PRESIDENT AND FELLOWS OF HARVARD COLLEGE, Cambridge, MA (US)

(72) Inventors: Wei-Ting CHEN, Cambridge, MA (US); Mohammadreza KHORASANINEJAD, Cambridge, MA (US); Alexander Yutong ZHU, Cambridge, MA (US); Jaewon OH, Cambridge, MA (US); Robert Charles DEVLIN, Cambridge, MA (US); Muhammad Aun Abbas ZAIDI, Cambridge, MA (US); Federico CAPASSO, Cambridge, MA (US)

(73) Assignee: PRESIDENT AND FELLOWS OF HARVARD COLLEGE, Cambridge, MA (US)

(21) Appl. No.: 16/332,348

(22) PCT Filed: Oct. 13, 2017
(86) PCT No.: PCT/US17/56673

§ 371 Date: Mar. 11, 2019

Related U.S. Application Data
(60) Provisional application No. 62/408,644, filed on Oct. 14, 2016.

(51) Int. Cl. G02B 5/00; G02B 1/00

(52) U.S. Cl. CPC G02B 5/001; G02B 2207/101; G02B 1/002

(57) ABSTRACT

An optical device comprises a substrate and a metasurface. The metasurface comprises a plurality of nanoscale elements disposed on the transparent substrate at different orientations. The orientations of the nanoscale elements define a phase profile such that the nanoscale elements convert an incident light into an output light propagating substantially without diffraction.

### CROSS-REFERENCE TO RELATED APPLICATIONS

This application claims the benefit of and priority to U.S. Provisional Patent Application No. 62/408,644, filed Oct. 14, 2016, which is incorporated herein by reference in its entirety.

### STATEMENT OF FEDERALLY SPONSORED RESEARCH OR DEVELOPMENT

This invention was made with Government support under FA9550-14-1-0389 and FA9550-16-1-0156, awarded by the Air Force Office of Scientific Research. The Government has certain rights in the invention.

### BACKGROUND

Bessel beams have attracted much attention due to their unique non-diffractive properties. Bessel beams encompass radiation beams (e.g., electromagnetic radiation beams) whose intensities are described by a Bessel function and propagate substantially without diffraction or spreading out. For example, zeroth order Bessel beams can be generated using a conical prism (known as an axicon) or an objective paired with an annular aperture. However, the former approach has a limited numerical aperture (NA), and the latter suffers from low efficiency, because most of the incident light is blocked by the aperture. Also, in order to generate higher-order Bessel beams an additional phase-modulating element is added, which in turn adds complexity and bulkiness to a system.

### SUMMARY

The present disclosure describes using dielectric metasurfaces to generate Bessel beams, and demonstrates new structures referred to herein as meta-axicons. The meta-axicons can have high NA (e.g., up to about 0.9 or more), and are capable of generating Bessel beams with full-width at half-maximum as small as about λ/3 across the human-visible spectrum (e.g., about 400 nanometers (nm) to about 700 nm, λ being the wavelength of the Bessel beams). Additionally, the Bessel beams generated by the meta-axicons have transverse intensity profiles independent of wavelength across at least a spectrum, such as the entire human-visible spectrum. The meta-axicons can be used in a variety of applications related to Bessel beams, including, e.g., laser fabrication, imaging, and optical manipulation.

### BRIEF DESCRIPTION OF THE DRAWINGS

FIG. 1A depicts a prism-type axicon.

FIG. 1B depicts an objective lens paired with an annular aperture.

FIG. 1C is an illustration of an example of a meta-axicon according to an embodiment of the present disclosure.

FIG. 1D is a scanning electron microscope image of a center portion of a fabricated meta-axicon.

FIG. 1E is a graph showing numerical aperture versus design angle for a prism axicon.

FIG. 2A, FIG. 2B, FIG. 2C, FIG. 2D, FIG. 2E, FIG. 2F and FIG. 2G illustrate characterizations of a meta-axicon according to an embodiment of the present disclosure.

FIG. 3A, FIG. 3B, FIG. 3C, FIG. 3D, FIG. 3E, FIG. 3F, FIG. 3G, FIG. 3H, FIG. 3I, FIG. 3J, FIG. 3K and FIG. 3L show theoretical (top row) and simulated (bottom row) normalized electric field intensities of a meta-axicon according to an embodiment of the present disclosure.

FIG. 3M shows simulation results for various numerical aperture meta-axicons according to embodiments of the present disclosure.

FIG. 3N shows theoretical and simulation results of ellipticity and polarization orientation angle of a meta-axicon according to an embodiment of the present disclosure.

FIG. 4A, FIG. 4B, FIG. 4C, FIG. 4D, FIG. 4E, FIG. 4F, FIG. 4G, FIG. 4H, FIG. 4I and FIG. 4J show measurement results for J₀ (zeroth-order) and J₁ (first-order) Bessel beams of a meta-axicon according to an embodiment of the present disclosure for different wavelengths.

FIG. 4K shows full-width at half-maximum measurements of a meta-axicon according to an embodiment of the present disclosure.

FIG. 4L plots normalized power of a laser used in a test of fabricated meta-axicons according to embodiments of the present disclosure.

FIG. 5 illustrates a test setup arranged to characterize fabricated meta-axicons according to embodiments of the present disclosure.

### DETAILED DESCRIPTION

Non-diffracting Bessel beams are described by a set of solutions to the free space Helmholtz equation, and have transverse intensity profiles that can be described by Bessel functions of the first kind. Bessel beams exhibit many interesting properties, such as non-diffraction, self-reconstruction, and provision of optical pulling forces. The scalar form of Bessel beams propagating along a z-axis can be described in cylindrical coordinates (r, ϕ, z) by equation (1a), where A is the amplitude.

E(r,ϕ,z)=A·exp(ik_{z}z)·Jₙ(kᵣr)·exp(±inϕ) (1a)

In equation (1a), k_{z} and kᵣ are respectively longitudinal and transverse wavevectors which satisfy equation (1b), and A in equation (1b) is the wavelength of the Bessel beam.

$$\sqrt{{k}_{z}^{2} + {k}_{r}^{2}} = k = \frac{2 π}{λ} \qquad ( 1 b )$$

Equation (1a) shows that the transverse intensity profiles of Bessel beams are independent of the z-coordinate, which lead to the non-diffracting properties of the Bessel beams. Equation (1a) also indicates that higher-ordered Bessel beams (orders for n≠0) carry orbital momentum, and have zero intensity along the z-axis because of the phase singularity resulting from the exp(±inϕ) term of Equation (1a).

Ideal Bessel beams are not spatially limited and carry infinite energy. Thus, ideal Bessel beams can be approximated within a finite region by a superposition of plane waves. The approximation of idea Bessel beams can be achieved using a comparative axicon by symmetrically refracting incident plane waves towards an optical axis of a conical prism (the axicon) to generate a J₀ Bessel beam (order of n=0, or zeroth order).

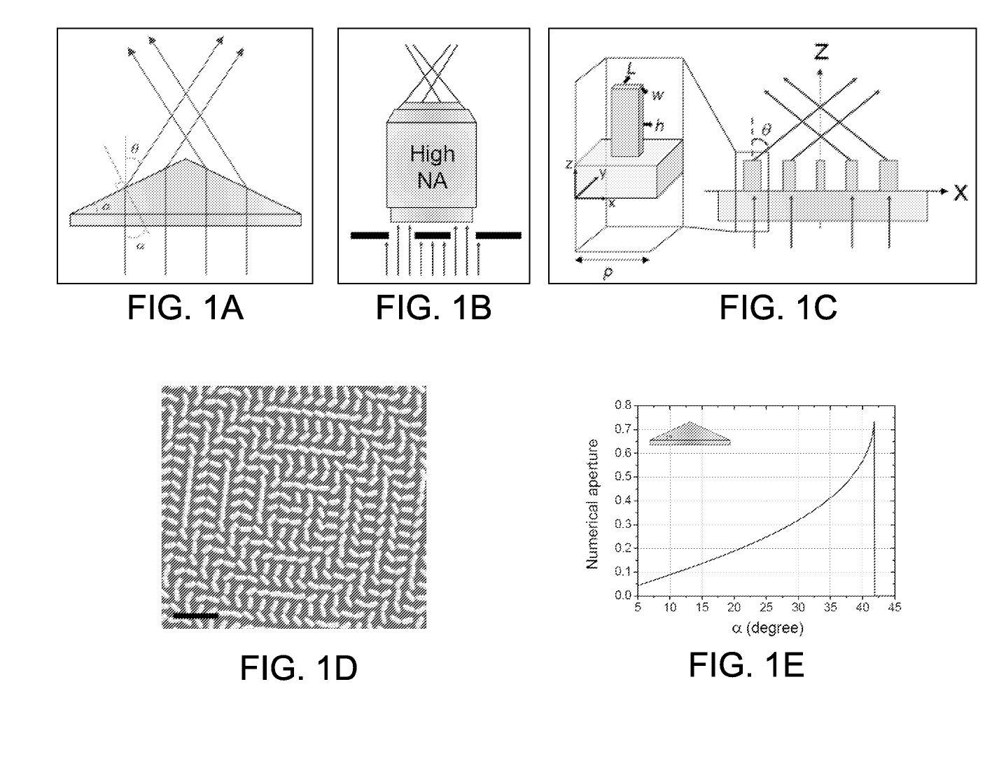

FIG. 1A depicts a comparative prism-type axicon. The numerical aperture (NA) of an axicon is related to an angle α (shown in FIG. 1A) as shown in equation (2), where n is a refractive index of the constituent material of the axicon, such as glass.

NA≡sin(θ)=sin(sin⁻¹(n·sin(α))−α) (2)

Equation (2) and FIG. 1A show that, for a given refractive index of the constituent material, to achieve high NA axicons, α is increased. However, for example, considering a refractive index of 1.5, typical of silica-based glass, total internal reflection occurs when α is greater than 42′. Thus, the NA of a comparative axicon may not exceed 0.75 (as shown in FIG. 1E). The specification of the NA, in turn, also constrains a minimum achievable full-width at half-maximum (FWHM) of a resultant Bessel beam. Further, a tip of such a manufactured refractive axicon is not adequately sharp as in the ideal case, which again affects the FWHM of the Bessel beam. Herein, the FWHM of the zeroth-order Bessel beam J₀ is defined as a distance between two points at half of the maximum intensity of the center bright spot, and can be derived from equation (1a) as shown in equation (3), where

$${k}_{r} = \frac{2 π}{λ} \cdot NA . \\ \begin{matrix}{FWHM}_{{J}_{0}} = \frac{2.25}{{k}_{r}} = \frac{0.358 \cdot λ}{NA} & ( 3 )\end{matrix}$$

Similarly, the FWHM of a J₁ Bessel beam is defined as a width of the central dark spot from the half maximum intensity of its closest ring, and is given by equation (4).

$${FWHM}_{{J}_{1}} = \frac{1.832}{{k}_{r}} = \frac{0.292 \cdot λ}{NA} \qquad ( 4 )$$

In the case of a comparative axicon, the NA is almost constant within the visible region, due to a weak dispersion of glass. Thus, the FWHM of the J₀ beam generated by the comparative axicon is proportional to wavelength and varies accordingly. For example, upon changing wavelength from 400 nm to 700 nm, a difference of about 175% was observed in the FWHM of a comparative prism axicon.

Alternatively, a high NA objective lens paired with an annular aperture can be used to generate Bessel beams with subwavelength FWHMs, as depicted in FIG. 1B. However, this configuration is not efficient because a large percentage of the incident light is blocked by the aperture.

For both the prism axicon and the objective lens paired with an annular aperture, phase-modulating components, such as spatial light modulators or spiral phase plates, can be added to generate higher-ordered Bessel beams. However, the phase-modulating components make the axicon bigger, bulkier, and more costly.

According to some embodiments of the present disclosure, meta-axicons based on metasurfaces having subwavelength-spaced phase shifters can be used instead of comparative axicons or objective lens paired with an annular aperture to generate Bessel beams of any order.

Unlike comparative phase-modulating devices (e.g., spatial light modulators), metasurface-based devices can achieve subwavelength spatial resolution, which provides for deflection of light to very large angles. Subwavelength spatial resolution provides a capability to realize efficient, high NA optical components, including axicons and lenses capable of generating beams with small FWHM. Various applications, including (but not limited to) scanning microscopy, optical manipulation, and lithography, benefit from subwavelength FWHM to achieve high spatial resolution, strong trapping force and subwavelength feature sizes, respectively.

In the present disclosure, meta-axicons with high NA of, e.g., about 0.9 in the visible region are demonstrated. These meta-axicons are capable of generating not only the zeroth-order, but also higher ordered Bessel beams with FWHM of about one third of the wavelength of incident light without the use of additional phase-modulating components. Additionally, by incorporating suitable phase shifters in the metasurfaces, the transverse field intensity profiles can be maintained independent of the wavelength.

FIG. 1C is an example of a meta-axicon according to an embodiment of the present disclosure. The meta-axicon includes nano-fins arranged on a base (e.g., a transparent substrate). In one or more embodiments, the nano-fins are made of, e.g., titanium dioxide (TiO₂). In addition to TiO₂, other suitable dielectric materials include those having a light transmittance over the visible spectrum of at least about 40%, at least about 50%, at least about 60%, at least about 70%, at least about 80%, at least about 85%, at least about 90%, or at least about 95%. For example, other suitable dielectric materials can be selected from, e.g., oxides, nitrides, sulfides, pure elements, or a combination of two or more thereof.

The nano-fins each have a same height h, length L, and width W by design. The nano-fins are arranged in a lattice (e.g., a square or hexagonal lattice), and are positioned at various angles with respect to each other. Aspect ratios of nano-fins (e.g., a ratio of height to length or a ratio of height to width) can be greater than one, at least about 1.5:1, at least about 2:1, at least about 3:1, at least about 4:1, at least about 5:1, at least about 6:1, or at least about 10:1.

To improve performance of the meta-axicon, each nano-fin is designed to act as a half-waveplate, converting incident circularly polarized light to its orthogonal polarization state. This is accompanied by a phase acquisition associated with a rotation angle (orientation) of the nano-fin, referred to as Pancharatnam-Berry phase. This technique allows a desired phase profile of the nano-fin to be tailored (and by tailoring the individual nano-fins, and also tailoring a desired phase profile of the meta-axicon). The h, L, and W parameters of the nano-fins are determined, for example, using a three-dimensional finite difference time domain (FDTD) technique to maximize circular polarization conversion efficiency. For example, at a design wavelength of λ_{d}=405 nm, simulated polarization conversion efficiencies of the nano-fin greater than 90% can be obtained.

For the generation of a zeroth order Bessel beam, a meta-axicon may have a radial phase profile φ(r) with a phase gradient as shown in equation (5).

$$\frac{d ϕ}{dr} = - \frac{2 π}{{λ}_{d}} sin ( θ ) \qquad ( 5 )$$

This can be understood from the generalized Snell's law, and applying a condition that all light rays are to be refracted by a same angle θ at a design wavelength λ_{d}. Sin(θ) is the numerical aperture. Integrating equation (5) gives equation (6), where \sqrt{x²+y²}=r.

$$ϕ ( x , y ) = 2 π - \frac{2 π}{{λ}_{d}} \cdot \sqrt{{x}^{2} + {y}^{2}} \cdot NA \qquad ( 6 )$$

For generation of higher order Bessel beams, a term nϕ is added, where ϕ=a tan(y/x) is the azimuthal angle, which represents a phase of an optical vortex imparted to deflect light. With the addition of the term, equation (6) becomes equation (7).

$$ϕ ( x , y ) = 2 π - \frac{2 π}{{λ}_{d}} \cdot \sqrt{{x}^{2} + {y}^{2}} \cdot NA \vert + n φ \qquad ( 7 )$$

This phase profile (equation (7)) is imparted by rotation of each nano-fin at a position (x, y) by an angle

$${θ}_{nf} ( x , y ) = \frac{ϕ ( x , y )}{2} ,$$

for the case of left-handed polarized incidence.

FIG. 1D is a scanning electron microscope image of a center portion of a fabricated meta-axicon satisfying equation (7).

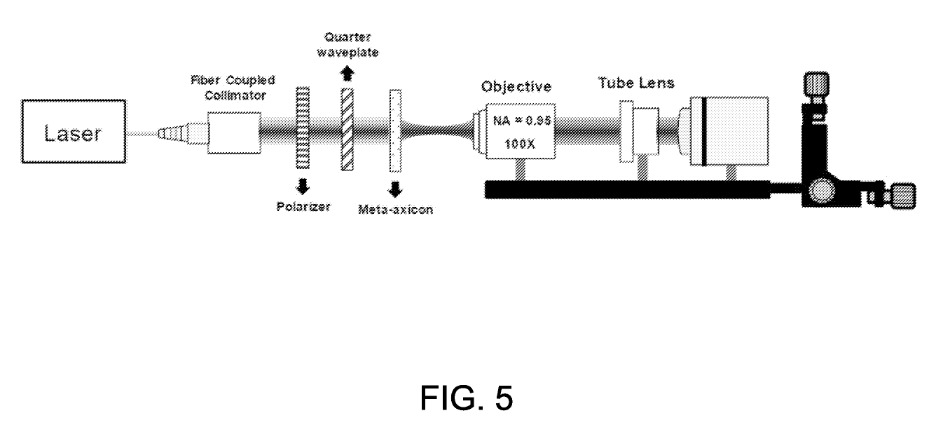

A custom-built microscope (as shown FIG. 5) was used to characterize the meta-axicons with design wavelength λ_{d}=405 nm and design NA=0.9.

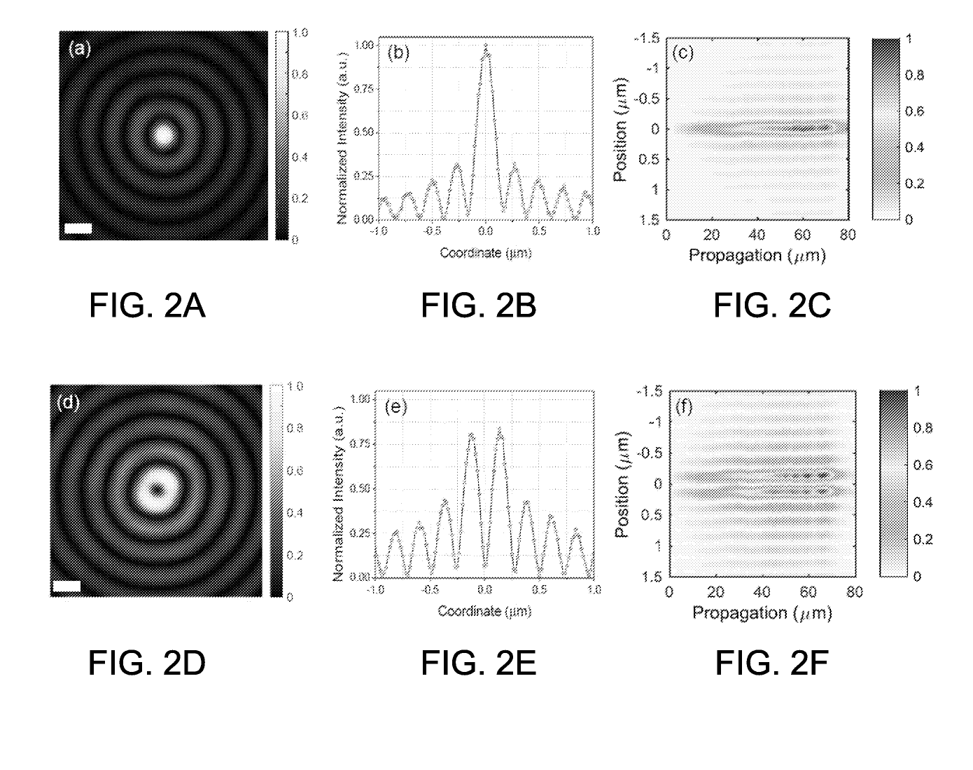

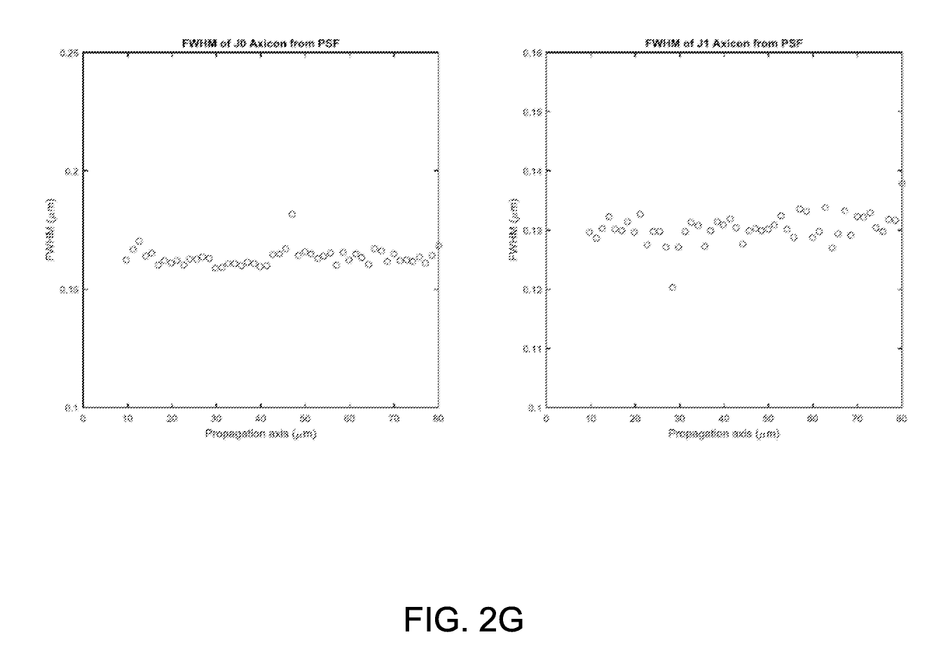

FIGS. 2A-2F illustrate characterizations of a meta-axicon according to an embodiment of the present disclosure, with respect to the J₀ and J₁ Bessel beams at λ=405 nm. FIGS. 2A-2C relate to the J₀ Bessel beam, and FIGS. 2D-2F relate to the J₁ Bessel beam.

FIGS. 2A and 2D show a measured transverse intensity profile of the J₀ and J₁ Bessel beams at λ=405 nm.

FIGS. 2B and 2E show an intensity along a horizontal cut across the meta-axicon center, for the J₀ and J₁ Bessel beams at λ=405 nm. The FWHM of the J₀ Bessel beam was observed to be about 163 nm with about 3.5 nm standard deviation, which agrees well with its theoretical value of 160 nm (equation (3)). The FWHM of the J₁ Bessel beam was observed to be about 130 nm with about 1.75 nm standard deviation, which agrees well with its theoretical value of 131 nm (equation (4)).

FIGS. 2C and 2F show a point spread function (PSF) of the J₀ and J₁ Bessel beams. Their FWHMs at different planes normal to the propagation axis are provided in FIG. 2G. Both PSFs have a depth of focus of 75 micrometers (μm) (150λ). This value is close to the theoretical value obtained using geometric optics,

$$\frac{D}{2 tan ( a sin ( NA ) )} = 72 μ m ,$$

where D=300 μm is a diameter of the meta-axicon.

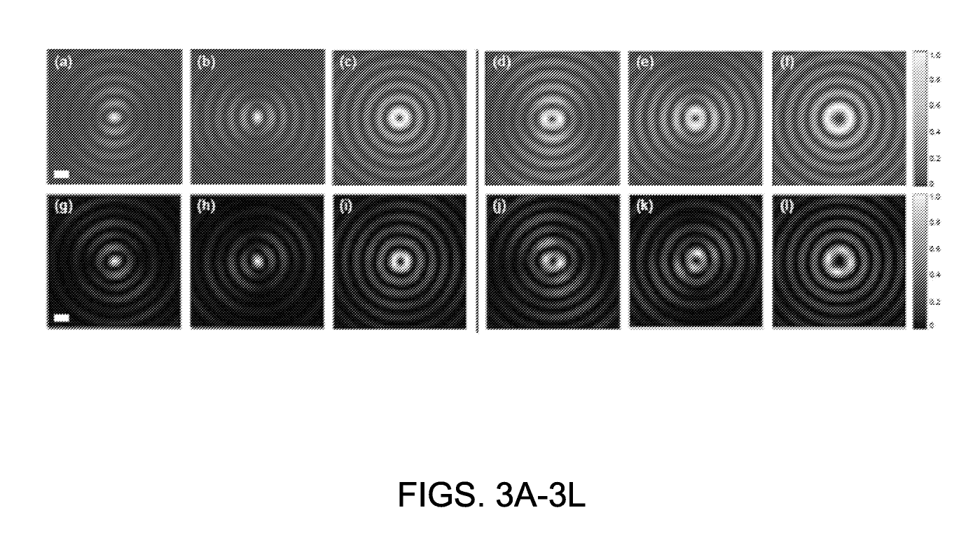

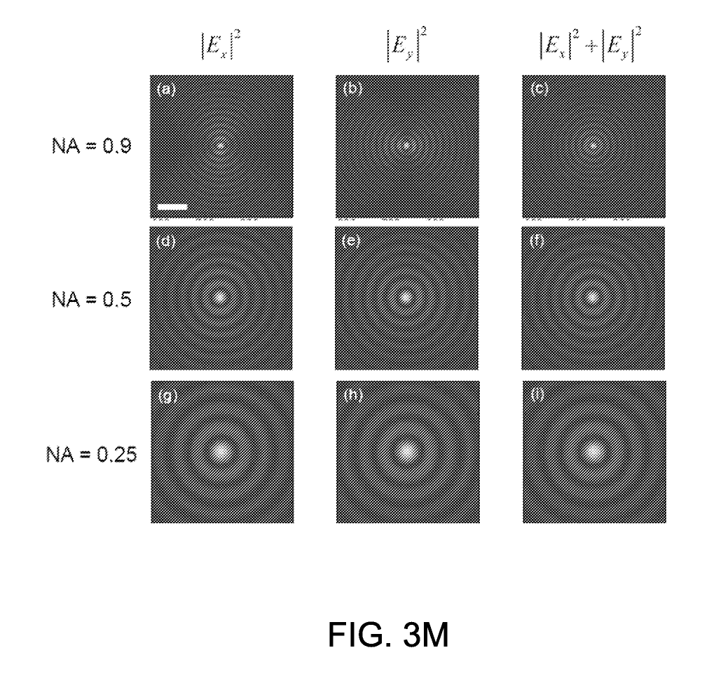

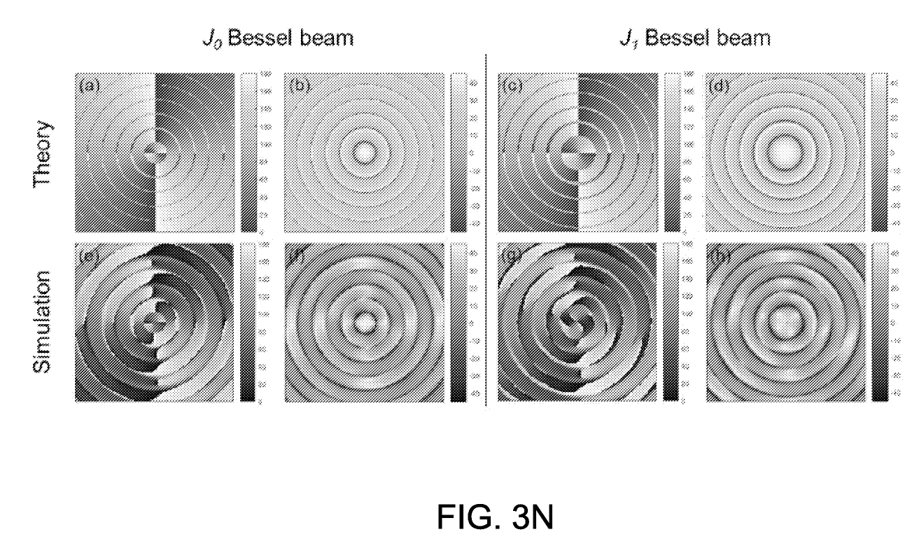

To understand the polarization properties of the J₀ and J₁ Bessel beams generated by the meta-axicons with NA=0.9, FIGS. 3A-3L show theoretical (top row) and simulated (bottom row) normalized electric field intensities |Ex|², |Ey|², and |Ez|². FIGS. 3A-3C and 3G-3I are results for the J₀ Bessel beam, and FIGS. 3D-3F and 3J-3L are results for the J₁ Bessel beam. Electric field intensity |Ex|² is shown in FIGS. 3A, 3D, 3G, 3J, electric field intensity |Ey|² is shown in FIGS. 3B, 3E, 3H, 3K, and electric field intensity |Ez|² is shown in FIGS. 3C, 3F, 3I, 3L. A portion of (e.g., less than all) of the meta-axicon was simulated due to limited computational resources.

There is a slight deviation of the simulation results from theory results, which is caused by uncoupled light from the nano-fins and the effects at the boundary of the simulation. Note that for either |Ex|² (FIGS. 3A and 3D) or |Ey|² (FIGS. 3B and 3E), in theory a shape of the J₀ and J₁ Bessel beams at their respective centers may be elliptical rather than circular. For example, as shown in FIGS. 3D and 3E, for J₁, the center regions are accompanied by two brighter spots at the end of the long axis of the ellipse. Moreover, the intensity of |Ex|² and |Ey|² show variation of the side lobes, which is also observed in the corresponding simulation results (FIGS. 3J and 3K). In addition, |Ez|² is described by a Bessel function one order larger than its transverse electric field. These properties can be explained by considering the vector form of Bessel beams. The theoretical vector solutions of the electric field of a Bessel beam propagating along a z-direction in cylindrical coordinates are shown in equation (8), where C_{TM} and C_{TE} are complex numbers associated with the constituent transverse magnetic (TM) and transverse electric (TE) waves of Bessel beams, and η is a phase difference between C_{TM} and C_{TE}.

$$\vec{E} ( x , y , z ) = {E}_{0} \cdot {e}^{{ik}_{r} z} {e}^{i ( n - 1 ) φ} ( \begin{matrix}( - {C}_{TE} \frac{{J}_{n} ( {k}_{r} r ) + {J}_{n + 2} ( {k}_{r} r )}{2} + i \cdot {C}_{TM} {e}^{i η} \sqrt{1 - {NA}^{2}} \frac{{J}_{n} ( {k}_{r} r ) - {J}_{n + 2} ( {k}_{r} r )}{2} ) \hat{r} \\ - ( {C}_{2 M} {e}^{i η} \sqrt{1 - {NA}^{2}} \frac{{J}_{n} ( {k}_{r} r ) + {J}_{n + 2} ( {k}_{r} r )}{2} + i \cdot {C}_{TE} \frac{{J}_{n} ( {k}_{r} r ) - {J}_{n + 2} ( {k}_{r} r )}{2} ) \hat{φ} \\ NA \cdot {C}_{TM} {e}^{i η} {J}_{n + 1} ( {k}_{r} r ) \hat{z}\end{matrix} ) \qquad ( 8 )$$

For circularly polarized Bessel beams and the meta-axicons described, C_{TE} is equal to C_{TM}, η=±π/2, NA=0.9, n=0 for J₀ Bessel beam, and n=1 for J₁ Bessel beam. For high NA Bessel beams, the electric field of the z-component results from TM waves: the higher the NA, the more contribution to E_{z}. The Ēᵣ and Ē_{ϕ} mainly result from TE wave contribution, since the term \sqrt{1−NA²} is relatively small for a high NA case. The term

$$\frac{{J}_{n} ( {k}_{r} r ) + {J}_{n + 2} ( {k}_{r} r )}{2}$$

contributes to localized intensity near the center spot or the most inner ring, as

$${J}_{n} ( {k}_{r} r ) \approx \sqrt{\frac{2}{π r}} cos ( r - \frac{n π}{2} )$$

for large r, such that Jₙ(kᵣr) and Jₙ₌₂(kᵣr) cancel each other due to a π phase difference. The intensity distribution of side lobes away from the center of a Bessel beam is due to another term,

$$\frac{{J}_{n} ( {k}_{r} r ) + {J}_{n + 2} ( {k}_{r} r )}{2} .$$

When cylindrical coordinates (r, ϕ) are transformed to Cartesian coordinates (x, y) using Ēₓ=Ēᵣ·cos(ϕ)−Ē_{ϕ}·sin(ϕ), there may be cos(ϕ) modulation, resulting in the elliptical shape, and a corresponding modulation of sin(O) for the side lobe, which is shown in FIGS. 3A and 3D. This may be a signature feature of high NA Bessel beams (see a comparison with lower NA Bessel beams in FIG. 3M). Due to the spatially varying intensity of Eₓ and E_{y}, the Bessel beams for high NA are not homogeneously polarized, but rather show space-variant polarization states (see FIG. 3N for plots of ellipticity and polarization orientation angle). Therefore, only the center part of the J₀ Bessel beam can be circularly polarized in the case of high NA.

A wavelength dependency of the FWHM of Bessel beams can be compensated by design (equations (3) and (4)). As mentioned previously, the transverse intensity profile is determined by the facto

$${k}_{r} = \frac{2 π}{λ} \cdot NA .$$

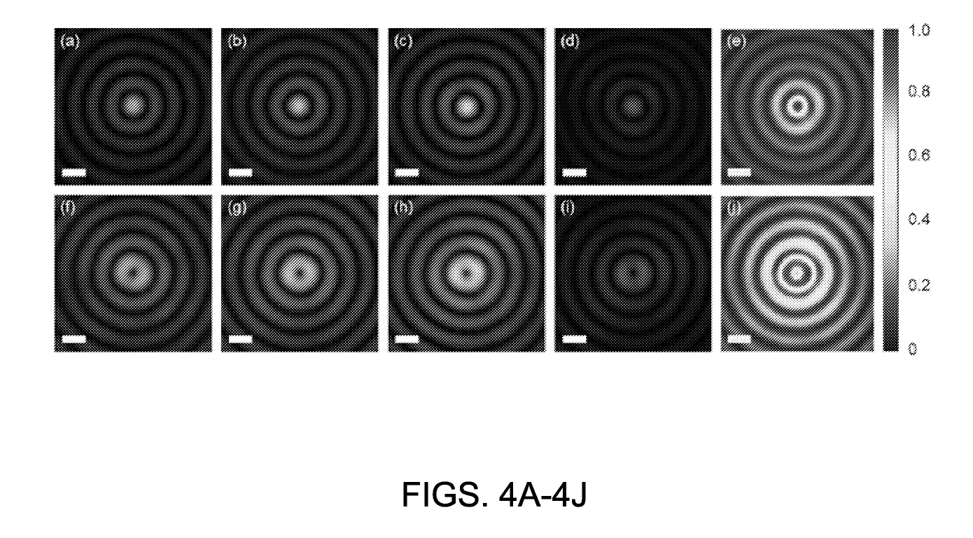

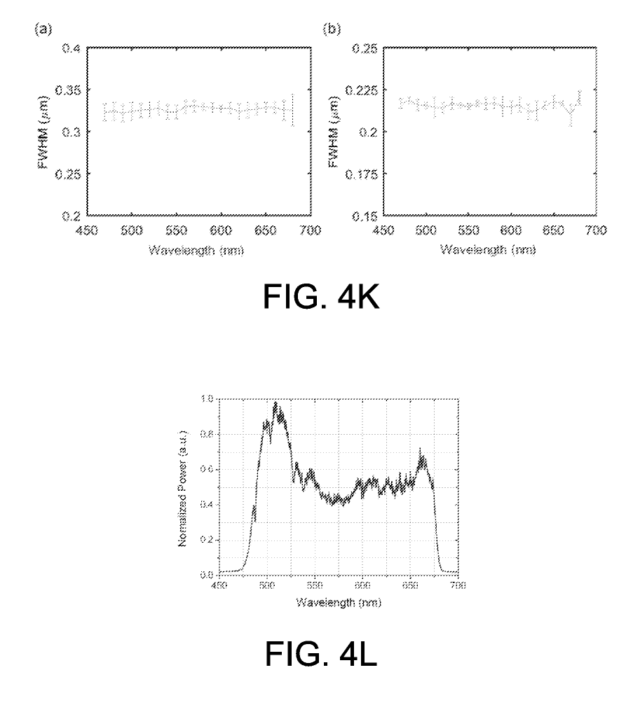

### Here,

$$NA = \frac{λ}{2 π} ∇ ϕ ( x , y , λ ) ,$$

where ϕ follows equation (7). Therefore kᵣ depends on the phase gradient ∇φ(x, y, λ), which can be designed to be wavelength-independent using the Pancharatnam-Berry phase concept. In this case, the phase gradient is a constant, and the NA is proportional to the wavelength λ. This manifests experimentally, in the form of the increasing diameters of rings in the Fourier plane of the meta-axicons for increasing wavelength. To demonstrate this unique characteristic across a broad wavelength region, two meta-axicons were designed for NA=0.7 at the wavelength λ=532 nm. Each nano-fin (design parameters L=210 nm, W=65 nm, h=600 nm) was arranged in a square lattice, with a lattice constant of 250 nm. FIGS. 4A-4D and 4F-4I show the corresponding J₀ and J₁ Bessel beams for different wavelengths (A=480 nm, 530 nm, 590 nm, and 660 nm) with a bandwidth of 5 nm. The FWHM of J₀ and FWHM of J₁ for each wavelength, spanning 470 nm to 680 nm, are shown in FIG. 4K (FWHM of J₀ on the left, FWHM of J₁ on the right). FIGS. 4A-4D, 4F-4I and 4K indicate that the intensity profile for different wavelengths varies weakly, confirming wavelength-independent behavior. It is notable that for these measurements, the distance between the meta-axicon and objective lens was kept unchanged.

The measurements were repeated using a supercontinuum laser of bandwidth 200 nm centered at 575 nm (See FIG. 4L for a power spectrum of the laser). The intensity profiles (FIGS. 4E and 4J) for J₀ and J₁ remain unchanged with slight blurring. It is important to note that to generate high NA and wavelength-independent Bessel beams, the Nyquist sampling theorem and wavelength-independent phase gradient conditions both should be satisfied. According to the Nyquist sampling theorem, the phase profile is sampled as given by equation (7) in the spatial domain with a rate that is at least twice the highest transverse optical momentum. Thus, a size of the unit cell may be equal to or smaller than

$$\frac{λ}{2 \cdot NA} ,$$

which cannot be satisfied by comparative diffractive components. For example, spatial light modulators can have about 6 μm pixel sizes, and photo-aligned liquid crystal devices can have, for example, a phase gradient of about π/μm, corresponding to a maximum achievable NA of about 0.03 and 0.26 in the visible region, respectively.

Also note that the phase profile of metasurfaces can be designed by varying geometric sizes (e.g., length, width or diameter) of the nanostructures pixel by pixel. However, such metasurfaces (e.g., not designed according to Pancharatnam-Berry phase) are accompanied by strong amplitude differences between each pixel at wavelengths away from the design wavelength. These discrepancies become more significant within the absorption region of the constituent materials used. In addition, the unwanted amplitude difference between each pixel can result in the diffraction of light to multiple angles, changing the profile of the Bessel beams. Utilizing the Pancharatnam-Berry phase approach minimizes a relative amplitude difference between each nano-fin for all wavelengths in the case of circularly polarized illumination, because a design size of each nano-fin is identical. This concept was experimentally demonstrated by measuring meta-axicons with silicon nano-fins from the near-infrared to the visible spectrum, where silicon becomes intrinsically lossy. It was observed that the sizes of the Bessel beam remain constant over the wavelength range of about 532 nm to about 800 nm.

In summary, as a superior alternative to using comparative prism axicons or an objective paired with an annular aperture, high NA meta-axicons capable of generating Bessel beams of different orders in a single device have been described and demonstrated. The high NA meta-axicons are efficient and compact. The FWHM of J₀ and J₁ Bessel beams were shown to be respectively as small as about 160 nm and 130 nm at a design wavelength λ=405 nm. This size is maintained for an exceptionally large distance of, e.g., at least about 150λ (depth of focus). Polarization is space-variant due to the high NA. By tailoring the phase profile of the meta-axicons, the FWHMs of generated Bessel beams are independent of the wavelength of incident light. These meta-axicons can be mass-produced with large diameter using presently available industrial manufacturing (deep UV steppers, nano-imprint). These properties show great promise in potential applications ranging from laser lithography and manipulation to imaging.

Measurement Set-Up.

Meta-axicons were characterized using a custom-built microscope (shown in FIG. 5) including of a fiber-coupled laser and collimator, a linear polarizer (Thorlabs GTH10M), a quarter-waveplate (Thorlabs AQWP05M-600), and an Olympus objective lens (100×, NA=0.95) paired with a tube lens (focal length f=180 mm) to form an image on a camera (IDS Inc. UI-1490SE). An ultra-narrow linewidth laser (100 MHz line width from Ondax. Inc.) or a supercontinuum laser (SuperK and Varia from NKT) were selectively used. Note that to precisely determine the size of Bessel beams, an imaging system with 100× magnification and a monochromatic CMOS camera with a small pixel size of 1.67 μm×1.67 μm was used. The FWHM of J₀ and J₁ Bessel beams were obtained by fitting the main and first side lobe curves, respectively.

Simulation.

Three dimensional full wave simulation was performed by a commercial software (Lumerical Inc.) based on the FDTD technique. To theoretically determine the polarization conversion efficiency, an array of TiO₂ nano-fins was arranged in such a way as to deflect light to a particular angle, and the efficiency is calculated by dividing a total deflected optical power by an input optical power. Periodic and perfectly matched layer boundary conditions were used along transverse and longitudinal directions, respectively, with respect to the propagation of incident circularly polarized light. To study polarization properties of the J₀ and J₁ Bessel beams, a meta-axicon with a small diameter of 30 μm (due to computational feasibility) but with the same NA=0.9 as fabricated devices was simulated.

Thus has been described a meta-axicon comprising a plurality of nano-fins, the meta-axicon having a phase profile such that a Bessel beam of order Jₙ is generated when the meta-axicon is illuminated with circularly polarized light. In an embodiment, n≥0. In another embodiment, n>1. In an embodiment, the meta-axicon outputs Bessel beams of order J₀ and J₁ responsive to incident light, and a polarization conversion efficiency of the nano-fins of the meta-axicon is at least about 90%. The phase profile can be designed such that the meta-axicon generates the Bessel beam with a wavelength-independent transverse field intensity profile. In an embodiment, the meta-axicon converts an incident light into an output light propagating substantially without diffraction, as characterized by, for example, a full-width at half-maximum (FWHM) of the output light being substantially uniform over a distance of at least 150λ, where λ is a design wavelength of the meta-axicon.

In an embodiment, the meta-axicon has a numerical aperture of at least about 0.9. In an embodiment, the meta-axicon has a numerical aperture of greater than about 1.0, such as by using an immersion technique.

In an embodiment, a cross-section of each nano-fin has two-fold symmetry. For example, the cross-section may be rectangular or elliptical.

In an embodiment, the plurality of nano-fins comprises phase shifters, which maintain a transverse field intensity profile independent of wavelength of the incident light.

In an embodiment, the nano-fins comprise titanium dioxide, silicon nitride, an oxide, a nitride, a sulfide, a pure element, or a combination of two or more of these. Such materials may have negligible material loss in the visible spectrum.

The meta-axicons described in the present disclosure are also useful for wavelengths outside the visible spectrum, such as in the near infrared, mid-infrared and/or far-infrared spectrum. In an embodiment, the nano-fins comprise silicon, amorphous silicon, gallium phosphide, or two or more of these. Such materials may have negligible material loss in the near infrared, mid-infrared and far-infrared spectrum.

As used herein, the singular terms “a,” “an,” and “the” may include plural referents unless the context clearly dictates otherwise.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, two numerical values can be deemed to be “substantially” the same if a difference between the values is less than or equal to ±10% of an average of the values, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, a characteristic or quantity can be deemed to be “substantially” uniform if a maximum numerical value of the characteristic or quantity is within a range of variation of less than or equal to +10% of a minimum numerical value of the characteristic or quantity, such as less than or equal to +5%, less than or equal to +4%, less than or equal to +3%, less than or equal to +2%, less than or equal to +1%, less than or equal to +0.5%, less than or equal to +0.1%, or less than or equal to +0.05%.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific embodiments thereof, these descriptions and illustrations do not limit the present disclosure. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. An optical device, comprising:
a substrate; and
a metasurface comprising a plurality of nanoscale elements disposed on the substrate at different orientations, wherein the orientations of the nanoscale elements define a phase profile such that the nanoscale elements convert an incident light into an output light propagating substantially without diffraction.

2. The optical device of claim 1, wherein each nanoscale element of the nanoscale elements is a phase shifter that shifts a phase of light incident upon the nanoscale element, and an extent of a phase shift depends on the orientation of the nanoscale element.

3. The optical device of claim 1, wherein the incident light is a circularly polarized light and the output light propagating substantially without diffraction is a Bessel beam of order Jₙ.

4. The optical device of claim 3, wherein the Bessel beam has an order of n=0, n=1, or n>1.

5. The optical device of claim 1, wherein the nanoscale elements comprise nano-fins, and the nano-fins have heights, widths and lengths that optimize polarization conversion efficiencies of the nano-fins.

6. The optical device of claim 5, wherein the polarization conversion efficiencies of the nano-fins are at least 90/%.

7. The optical device of claim 1, wherein the phase profile defined by the orientations of the nanoscale elements is a radial phase profile depending on a distance between each nanoscale element and a center of the metasurface.

8. The optical device of claim 7, wherein the radial phase profile further depends on a design wavelength of the metasurface and a numerical aperture of the metasurface.

9. The optical device of claim 1, wherein the nanoscale elements form a meta-axicon that symmetrically refracts the incident light towards an optical axis of the meta-axicon.

10. The optical device of claim 1, wherein the nanoscale elements form a meta-axicon that has a numerical aperture of at least 0.9 for a visible spectrum.

11. The optical device of claim 1, wherein the converted output light has a transverse field intensity profile satisfying a Bessel function.

12. The optical device of claim 1, wherein the converted output light has a transverse field intensity profile independent of a wavelength of the converted output light.

13. The optical device of claim 1, wherein the nanoscale elements are disposed on the substrate in a square or hexagonal lattice.

14. A meta-axicon device, comprising:
a substrate; and
a metasurface comprising a plurality of nanoscale elements disposed on the substrate with rotation angles set according to Pancharatnam-Berry phase.

15. The meta-axicon device of claim 14, wherein the nanoscale elements are phase shifters that convert a circularly polarized light into a Bessel beam of order Jₙ.

16. The meta-axicon device of claim 14, wherein the nanoscale elements are phase shifters that convert a circularly polarized light into a Bessel beam with a transverse field intensity profile independent of a wavelength of the Bessel beam.

17. The meta-axicon device of claim 14, wherein the nanoscale elements define a phase profile:
$$ϕ ( x , y ) = 2 π - \frac{2 π}{{λ}_{d}} \cdot \sqrt{{x}^{2} + {y}^{2}} \cdot NA$$
wherein x, y are spatial coordinates of a nanoscale element, NA is a numerical aperture of the metasurface, and λ_{d} is a design wavelength of the meta-axicon device.

18. The meta-axicon device of claim 14, wherein the nanoscale elements form a meta-axicon that symmetrically refracts an incident light towards an optical axis of the meta-axicon.

19. The meta-axicon device of claim 14, wherein each nanoscale element of the nanoscale elements is a half-waveplate configured to convert a circularly polarized light incident upon the nanoscale element into an orthogonal polarization state.

20. The meta-axicon device of claim 14, wherein the nanoscale elements have common dimensions.
